(19) United States
(12) Patent Application Publication
(10) Pub. No.: US 2025/0357788 A1
(43) Pub. Date: Nov. 20, 2025

(54) POWER CONTROL FOR POWER PROVIDERS AND ENERGY HARVESTING TRANSMITTERS

(71) Applicant: QUALCOMM Incorporated, San Diego, CA (US)

(72) Inventors: Ahmed ELSHAFIE, San Diego, CA (US); Alexandros MANOLAKOS, Athens (GR); Gabi SARKIS, San Diego, CA (US); Yuchul KIM, San Diego, CA (US); Zhikun WU, Beijing (CN); Huilin XU, Temecula, CA (US); Linhai HE, San Diego, CA (US); Seyedkianoush HOSSEINI, San Diego, CA (US); Wanshi CHEN, San Diego, CA (US); Peter GAAL, San Diego, CA (US); Tingfang JI, San Diego, CA (US); Krishna Kiran MUKKAVILLI, San Diego, CA (US)

(21) Appl. No.: 18/871,072

(22) PCT Filed: Jul. 30, 2022
(86) PCT No.: PCT/CN2022/109276

§ 371 Date: Dec. 2, 2024

(51) Int. Cl. H02J 50/00; H02J 50/20; H02J 50/80

(52) U.S. Cl. CPC H02J 50/001; H02J 50/20; H02J 50/80

(57) ABSTRACT

Methods, systems, and devices for wireless communications are described. Some wireless communications systems may support power control for energy providing devices and energy harvesting devices. For example, a wireless device may receive a first control signal indicating a set of energy transfer power control schemes, for an energy providing wireless device, or a set of data transfer power control schemes, for an energy providing wireless device. Additionally, the wireless device may receive a second control message activating a first energy transfer power control scheme or a first data transmission power control scheme, respectively. The wireless device may communicate, to one or more additional wireless device, a scheduling message scheduling transmission of an energy transfer signal or a data message, respectively, and may transmit the energy transfer signal or the data message in accordance with the first energy transfer power control scheme or the first data transmission power control scheme.

### CROSS REFERENCE

The present Application is a 371 national phase filing of International PCT Application No. PCT/CN2022/109276 by ELSHAFIE et al., entitled “POWER CONTROL FOR POWER PROVIDERS AND ENERGY HARVESTING TRANSMITTERS,” filed Jul. 30, 2022, which is assigned to the assignee hereof, and which is expressly incorporated by reference in its entirety herein.

### FIELD OF TECHNOLOGY

The following relates to wireless communications, including power control for power providers and energy harvesting transmitters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support power control for power providers and energy harvesting transmitters. Generally, the techniques described herein may enable power control for energy providing wireless devices (e.g., power providers) and energy harvesting wireless devices (e.g., energy harvesting transmitters). For example, an energy providing wireless device, may communicate first control signaling indicating multiple energy transfer power control schemes, where each energy transfer power control scheme may indicate how the energy providing wireless device is to determine a transmission power level for transmitting one or more energy transfer signals. In some cases, the energy providing wireless device may receive second control signaling indicating activation of a first energy transfer power control scheme of the multiple energy transfer power control schemes. Additionally, the energy providing wireless device may communicate, to one or more energy harvesting wireless devices, a scheduling message to schedule transmission of an energy transfer signal and may transmit the energy transfer signal at a transmission power level determined in accordance with the first energy transfer power control scheme. In some cases, the one or more energy harvesting wireless devices may performing an energy harvesting procedure to charge an energy storage device associated with a respective energy harvesting wireless device based on receiving the energy transfer signal.

Similarly, an energy harvesting wireless device, may communicate first control signaling indicating multiple data transmission power control schemes, where each data transmission power control scheme may indicate how the energy harvesting wireless device is to determine a transmission power level for transmitting one or more data messages. In some cases, the energy harvesting wireless device may receive second control signaling indicating activation of a first data transmission power control scheme of the multiple data transmission power control schemes. Additionally, the energy harvesting wireless device may communicate a scheduling message to schedule transmission of a data message and may transmit the data message at a transmission power level determined in accordance with the first data transmission power control scheme.

### BRIEF DESCRIPTION OF THE DRAWINGS

FIG. 1 illustrates an example of a wireless communications system that supports power control for power providers and energy harvesting transmitters in accordance with one or more aspects of the present disclosure.

FIG. 2 illustrates an example of a wireless communications system that supports power control for power providers and energy harvesting transmitters in accordance with one or more aspects of the present disclosure.

FIG. 3 illustrates an example of a wireless communications system that supports power control for power providers and energy harvesting transmitters in accordance with one or more aspects of the present disclosure.

FIG. 4 illustrates an example of a process flow that supports power control for power providers and energy harvesting transmitters in accordance with one or more aspects of the present disclosure.

FIG. 5 illustrates an example of a process flow that supports power control for power providers and energy harvesting transmitters in accordance with one or more aspects of the present disclosure.

FIGS. 6 and 7 show block diagrams of devices that support power control for power providers and energy harvesting transmitters in accordance with one or more aspects of the present disclosure.

FIG. 8 shows a block diagram of a communications manager that supports power control for power providers and energy harvesting transmitters in accordance with one or more aspects of the present disclosure.

FIG. 9 shows a diagram of a system including a device that supports power control for power providers and energy harvesting transmitters in accordance with one or more aspects of the present disclosure.

FIGS. 10 and 11 show flowcharts illustrating methods that support power control for power providers and energy harvesting transmitters in accordance with one or more aspects of the present disclosure.

### DETAILED DESCRIPTION

Some wireless communications systems may support energy harvesting. For example, an energy harvesting wireless device may harvest energy from an environment in which the energy harvesting wireless device is located and may store the energy (e.g., in a rechargeable battery). In some cases, the energy harvesting wireless device may harvest energy from an energy transfer signal transmitted by an energy providing wireless device. That is, an energy providing wireless device may transmit an energy transfer signal at a transmission power level and the energy harvesting wireless device may receive the energy transfer signal and perform an energy harvesting procedure to charge an energy storage device associated with the energy harvesting wireless device. However, conventional techniques may not support power control for energy providing wireless devices and energy harvesting wireless devices, which may result in inefficient operation of energy harvesting wireless devices, energy providing wireless devices, or both.

Accordingly, techniques described herein may support power control for transmission of energy transfer signals by energy providing wireless devices and energy transmission of data messages by energy harvesting wireless devices. For example, a wireless device, such as an energy providing wireless device or an energy harvesting wireless device, may support one or more power control schemes, which may be referred to as energy transfer power control schemes for an energy providing wireless device or data transmission power control schemes for an energy harvesting wireless device. Each power control scheme may specify how the wireless device determines a transmission power level for transmission of an energy transfer signal (e.g., by an energy providing wireless device) or a data message (e.g., by an energy harvesting wireless device). In some examples, a first power control scheme may indicate that the transmission power level is based on an indication received in a control message from a second wireless device. In some examples, a second power control scheme may indicate that the transmission power level may be based on a power class of an energy harvesting device receiving the energy transfer signal or transmitting the data message. In some examples, a third power control scheme may indicate that the transmission power level may be based on a pathloss, which may be an uplink pathloss, a sidelink pathloss, or a downlink pathloss. In some cases, the transmission power level may be based on one or more characteristics of the energy harvesting device receiving the energy transfer signal or transmitting the data message.

As such, the wireless device may receive a first control message indicating multiple power control schemes and a second control message indicating activation of a power control scheme from the multiple power control schemes. As such, the wireless device may communicate a scheduling message to schedule transmission of an energy transfer signal (e.g., by an energy providing wireless device) or a data message (e.g., by an energy harvesting wireless device) and may transmit the energy transfer signal or data message at a transmission power level determined in accordance with the activated power control scheme.

Transmitting an energy transfer signal in accordance with an activated energy transfer power control scheme of a set of energy transfer power control schemes may support efficient energy transfer which may result in reduced power consumption, more efficient charging, and more efficient utilization of communication resources, among other advantages. Additionally, transmitting a data message in accordance with an activated data transmission power control scheme may result in efficient data communication by an energy harvesting device which may result in reduced power consumption, more efficient utilization of communication resources, more efficient charging, and longer battery life, among other advantages.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to power control for power providers and energy harvesting transmitters.

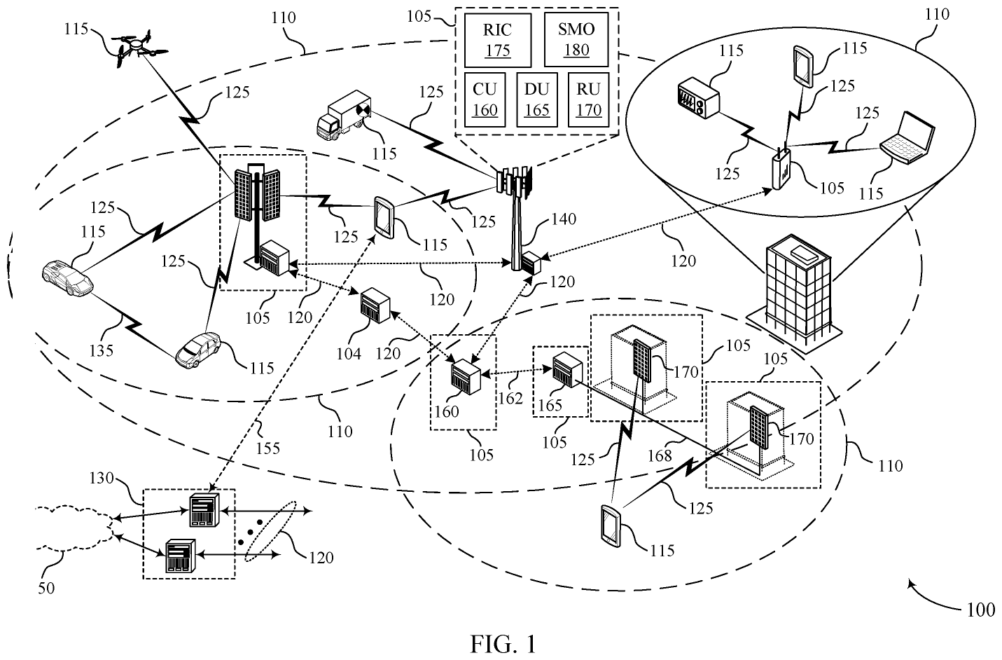

FIG. 1 illustrates an example of a wireless communications system 100 that supports power control for power providers and energy harvesting transmitters in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support power control for power providers and energy harvesting transmitters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of an RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support power control for transmission of energy transfer signals by energy providing wireless devices, such as energy providing network entities 105 or energy providing UEs 115, and energy transmission of data messages by energy harvesting wireless devices, such as energy harvesting network entities 105 or energy harvesting UEs 115. For example, an energy providing wireless device, such as an energy providing UE 115, may receive a first control message indicating a set of energy transfer power control schemes, where each energy transfer power control scheme specifies how the energy providing UE 115 determines a transmission power level for transmission of an energy transfer signal. In some cases, the energy providing UE 115 may receive a second control message activating a first energy transfer power control scheme of the set of energy transfer power control schemes. Additionally, the energy providing UE 115 may transmit a scheduling message, to one or more energy harvesting wireless devices, such as an energy harvesting UE 115, scheduling transmission of an energy transfer signal. Further, the energy providing UE 115 may transmit, to the energy harvesting UE 115, the energy transfer signal at a transmission power level in accordance with the first energy transfer power control scheme. In some cases, the energy harvesting UE 115 may receive the energy transfer signal and may perform an energy harvesting procedure to charge an energy storage device associated with the energy harvesting UE 115.

In another example, an energy harvesting wireless device, such as an energy harvesting UE 115, may receive a first control message indicating a set of data transmission power control schemes, where each data transmission power control scheme specifies how the energy harvesting UE 115 determines a transmission power level for transmission of a data message. In some cases, the energy harvesting UE 115 may receive a second control message activating a first data transmission power control scheme of the set of data transmission power control schemes. Additionally, the energy harvesting UE 115 may transmit a scheduling message, to one or more additional wireless devices, such as an additional UE 115, scheduling transmission of a data message. Further, the energy harvesting UE 115 may transmit, to the additional UE 115, the data message at a transmission power level in accordance with the first data transmission power control scheme.

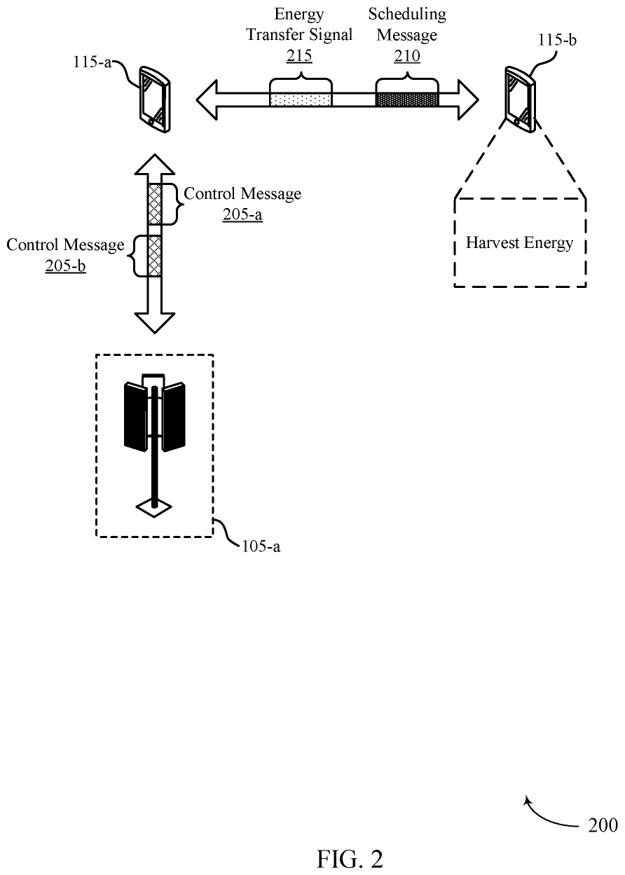

FIG. 2 illustrates an example of a wireless communications system 200 that supports power control for power providers and energy harvesting transmitters in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a and a UE 115-b), which may be examples of the corresponding devices described with reference to FIG. 1. In the example of FIG. 2, the network entity 105-a may be examples of a CU 160, a DU 165, an RU 170, a base station 140, an IAB node 104, or one or more other network nodes as described with reference to FIG. 1. In some cases, a UE 115-a, which may be an energy providing UE 115-a, may receive a control message 205-b activating a first energy transfer power control scheme of a set of energy transfer power control schemes supported by the UE 115-a.

Some wireless communications systems (e.g., reduced capability (RedCap) systems, non-RedCap systems, passive internet of things (PIOT) systems), such as the wireless communications system 200 may support wireless devices, such as UEs 115 or network entities 105, capable of harvesting energy from the environment of the wireless devices, which may be referred to as energy harvesting wireless devices. That is, an energy harvesting wireless device, may harvest energy from the environment, such as via solar, heat, or ambient RF radiation, and may store the energy in an energy storage device of the energy harvest wireless device, such as a rechargeable battery (e.g., different from backscatter communications based PIOT where a battery-less wireless device collects energy from ambient RF signals and redirects in like a radio frequency identifier (RFID) tag). In some cases, the energy harvesting wireless device may include RF components (e.g., power consuming) such as one or more analog-to-digital converters (ADCs), one or more mixers, and one or more oscillators.

In some other cases, an energy harvesting wireless device may support backscatter communication (e.g., in a 5G-Advanced system). That is, the energy harvesting wireless device (e.g., PIOT device) may not be associated with an energy storage device, such that the energy harvesting wireless device may receive an energy transfer signal and emit an information-bearing signal (e.g., at a data rate, power, density, etc.), which may be referred to as a backscatter modulated signal, based on the received energy transfer signal. Such energy harvesting wireless devices may support identification, tracking, authentication, authorization, access control, mobility management, security, and sensing, among other operations.

Additionally, or alternatively, an energy harvesting wireless device may be associated with a limited energy storage device (e.g., capacitor). Such energy harvesting wireless devices (e.g., supporting energy harvesting enabled communication services (EHECS) in 5G systems) may support power sourcing, security, access control, connectivity management, and positioning, among other operations.

In some cases, the energy harvesting wireless device may harvest energy intermittently based on available energy from the environment (e.g., according to enhanced protocols). For example, the amount of energy available for an energy harvesting wireless device to harvest form the environment may vary (e.g., the energy harvesting wireless device may expect variations in the amount of harvested energy and traffic). As such, an energy harvesting wireless device harvesting energy intermittently based on available energy from the environment may not support continuous transmission and/or reception for a duration greater than a threshold (e.g., may not sustain extended continuous transmission and/or reception).

In some cases, the wireless communications system 200 may support wireless devices, such as UEs 115 or network entities 105, capable of transmitting energy in the form of energy transfer signals, which may be referred to energy providing (e.g., power providing) wireless devices. For example, an energy providing wireless device may transmit (e.g., via uplink or sidelink) an energy transfer signal to an energy harvesting wireless device, and the energy harvesting wireless device may harvest energy from the energy transfer signal to charge an energy storage device associated with the energy harvesting wireless device. However, conventional techniques may not support power control for energy providing wireless devices and energy harvesting wireless devices, which may result in inefficient operation of energy harvesting wireless devices, energy providing wireless devices, or both.

Accordingly, techniques described herein may support power control for an energy providing wireless device, such as a UE 115-a, which may be an example of an energy providing UE 115-a. In some cases, the UE 115-a may receive, from a network entity 105-a, a control message 205-a indicating a set of energy transfer power control schemes, where each energy transfer power control scheme specifies how the UE 115-a is to determine a transmission power level (e.g., transmit power) for an energy transfer signal 215. Additionally, the UE 115-a may receive a control message 205-b activating (e.g., or deactivating) a first energy transfer power control scheme from the set of energy transfer power control schemes. In some cases, activating the first energy transfer power control scheme may be based on one or more carriers associated with the energy transfer signal 215, a bandwidth part associated with the energy transfer signal 215 (e.g., sidelink bandwidth part, uplink bandwidth part, downlink bandwidth part), a resource pool associated with the energy transfer signal 215, a congestion level, a QoS, or any combination thereof. The UE 115-a may transmit, to a UE 115-b, which may be an energy harvesting UE 115-b, a scheduling message 210 scheduling transmission of the energy transfer signal 215. Further, the UE 115-a may transmit the energy transfer signal 215 at a transmission power level in accordance with the first energy transfer power control scheme.

In some cases, the first energy transfer power control scheme may indicate that the UE 115-a is to transmit the energy transfer signal 215 at a defined (e.g., constant) transmission power level based on an indication (e.g., layer 1, layer 2, or layer 3 indication or pre-configuration) transmitted to or received from an additional wireless device (e.g., a network entity 105, a CU 160, a UE 115, a programmable logic controller (PLC), an RF power emitting controller), such as the network entity 105-a. For example, the UE 115-a may receive, from the network entity 105-a, control signaling (e.g., sidelink control information (SCI), MAC-control element (MAC-CE), RRC, downlink control information (DCI), or uplink control information (UCI)) associated with the energy transfer signal 215 (e.g., or received prior to the energy transfer signal 215 transmission) indicating a first transmission power level. As such, the UE 115-a may transmit, to the UE 115-b, the energy transfer signal 215 at the first transmission power level. In some cases, the UE 115-a may transmit or receive additional control signaling indicating a second (e.g., updated) transmission power level associated with the first energy transfer power control scheme, such that the UE 115-a may transmit an additional energy transfer signal 215 (e.g., scheduled via an additional scheduling message 210) at the second transmission power level (e.g., the transmission power level may be dynamically changed from time to time). In some examples, the transmission power level (e.g., constant power level) may be based on a power class or power type of the UE 115-b (e.g., wireless device to be charged), a current charging rate at the UE 115-b (e.g., from RF or other technologies), a threshold (e.g., required by RF) charging rate of the UE 115-b, a quality of service (QOS) of charging at the UE 115-b, a capacity of an energy storage device at the UE 115-b, a discharge rate of the UE 115-b, a charging priority associated with the UE 115-b, an energy cast type, or any combination thereof.

In some cases, the first energy transfer power control scheme may indicate that the UE 115-a is to transmit at full power to charge one or multiple UEs. This energy transfer power control scheme may be subject to a type of the UE 115-a, a capability of a power providing UE 115-a, a device power class of the UE 115-a, regulatory requirements, or any combination thereof.

In some cases, the first energy transfer power control scheme may indicate that the UE 115-a is to transmit the energy transfer signal 215 at a transmission power level based on a power class of the UE 115-a, the UE 115-b, or both. In some cases, the UE 115-a may receive, from the UE 115-b, an indication of the power class of the UE 115-b. The power class of the UE 115-b may be associated with a charging rate of the UE 115-b, a power density (e.g., upon arrival of the energy transfer signal 215) at the UE 115-b, a battery status (e.g., current battery status) of the UE 115-b, a QoS of charging at the UE 115-b, and one or more threshold (e.g., regulatory requirements) associated with the UE 115-b.

In some cases, the first energy transfer power control scheme may indicate that the UE 115-a is to transmit the energy transfer signal 215 at a transmission power level based on a pathloss (e.g., open-loop or closed-loop pathloss). For example, the UE 115-a may measure a pathloss (e.g., open-loop) associated with communications between the UE 115-a, with one or more additional wireless devices, or both. In some cases, the pathloss may be a downlink pathloss-based open-loop power control, an uplink pathloss-based open-loop power control, a sidelink pathloss-based open-loop power control, or any combination thereof. Additionally, or alternatively, the pathloss may be based on a frequency range associated with the communications, antennas at the UE 115-a used to transmit or receive the communications, or the like thereof.

In some cases, the first energy transfer power control scheme may indicate that the UE 115-a is to transmit the energy transfer signal 215 at a transmission power level based on a charging rate of the UE 115-b, a battery status (e.g., current battery status) of the UE 115-b, a QoS of charging at the UE 115-b, a discharge rate of the UE 115-b (e.g., due to the UE 115-b being active (e.g., turned on), energy storage unit leakage, or both), a charging priority (e.g., level 1 or level 3 priority) associated with the UE 115-b, an energy cast type associated with the UE 115-b (e.g., unicast transmission of the energy transfer signal 215 to one UE 115, groupcast transmission of the energy transfer signal 215 to a group of UEs 115, multicast transmission of the energy transfer signal to all UEs 115), or any combination thereof (e.g., to perform closed-loop power control), any of which may be indicated to the UE 115-a in capability signaling received from the UE 115-b. The energy cast type (e.g., unicast, groupcast, broadcast) may be for a single or multiple energy harvesting UEs, and may be signaled to change a single parameter, multiple parameters, or all parameters, described herein, including, for example, a maximum transmission power level, a fixed transmission power level, a dynamically change a first transmission power level to a second transmission power level, or the like, to UEs harvesting energy for a particular cast type.

In some examples, the UE 115-b may operate at a high discharge rate, such that the UE 115-a may transmit the energy transfer signal 215 at a higher transmission power level (e.g., compared to a low discharge rate) to account for the high discharge rate. In some cases, the UE 115-b may be associated with a threshold (e.g., minimum or default) discharge rate. In another example, the UE 115-b may transmit, to the UE 115-a, a request for energy transfer (e.g., to power the UE 15-b) indicating a charging priority and may transmit the energy transfer signal at a transmission power level based on the charging priority. In some cases, the charging priority may be based on a priority associated with a data transmission to be received (e.g., or being received) by the UE 115-b (e.g., the UE 115-b is being charged to receive the data transmission by UE 115-a or another energy providing device), based on a priority associated with a data transmission to be transmitted by the UE 115-b (e.g., priority of data buffered at the UE 115-b), based on a priority associated with a remaining packet delay budget of a packet to be received or transmitted by the UE 115-b (e.g., or both if the UE 115-b will use the power from the energy transfer signal 215 for reception and transmission), or any combination thereof. In another example, the UE 115-a may transmit the energy transfer signal 215 to a group of UEs 115 (e.g., according to an energy cast associated with groupcast transmissions to a group of UEs 115) such that the UE 115-a may transmit the energy transfer signal 215 at a higher transmission power level (e.g., max, fixed or dynamic) than a transmission power level associated with transmission of the energy transfer signal 215 to the UE 115-b (e.g., according to an energy cast associated with unicast transmissions to a single UE 115).

In some cases, the UE 115-a may receive, from the UE 115-b, an indication of the charging rate of the UE 115-b, the battery status of the UE 115-b, the QoS of charging at the UE 115-b, a discharge rate of the UE 115-b, a charging priority associated with the UE 115-b, an energy cast type associated with the UE 115-b, or any combination thereof.

In some cases, the first energy transfer power control scheme may be associated with a lowest transmission power level from a set of transmission power levels associated with the set of energy transfer power control schemes. That is, the first energy transfer power control scheme may be associated with a lowest transmission power level of the aforementioned energy transfer power control schemes. In some examples, a value of the transmission power level used for any of the aforementioned energy transfer power control schemes may be defined, configured, or pre-configured per carrier, per energy dedicated BWP, per sidelink bandwidth part, per uplink bandwidth part, per resource pool, based on congestion level, based on priority, based on quality of service, or any combination thereof.

Additionally, or alternatively, multiple energy providing UEs 115 may coordinate and transmit energy transfer signals 215 (e.g., provide power) to a single or multiple energy harvesting UEs 115. For example, the UE 115-a may be associated with a group of energy providing UEs 115 transmitting energy transfer signals 215 to the UE 115-b. In such cases, the first energy transfer power control scheme activated by the control message 205-b may indicate that each energy providing UE 115 in the group of energy providing UEs 115 may transmit a respective energy transfer signal 215 at a transmission power level based on a pathloss (e.g., uplink pathloss, sidelink pathloss, or downlink pathloss). For example, the pathloss many be based on a greatest (e.g., highest) pathloss measurement from a set of pathloss measurements, including a pathloss measurement performed by each energy providing UE 115 in the group of energy providing UEs 115 (e.g., for a given interface). For example, as described previously, the UE 115-a may measure a pathloss (e.g., open-loop) associated with communications between the UE 115-a and one or more additional wireless devices.

In some cases, the UE 115-a may be a UE 115 that initiated (e.g., started) transmission of the energy transfer signal 215 (e.g., initiated an energy transfer operation using layer 1, layer 2, or layer 3 signaling). In some other cases, the UE 115-a may be a UE 115 that selected or reserved (e.g., requested a network entity 105 in mode 1 random access) energy transfer resources associated with the energy transfer signal 215. In some cases, the UE 115-a may be a UE 115 that first transmitted the energy transfer signal 215. In some other cases, the UE 115-a may be a UE 115 indicated via the control message 205-b received from a control unit (e.g., indicated by a CU 160 or network entity 105 signaling to start the energy transfer operation). In some cases, the UE 115-a may transmit an indication (e.g., via layer 1, layer 2, or layer 3 signaling) of the transmission power level based on the pathloss to each energy providing UE 115 in the group of energy providing UEs 115. Additionally, or alternatively, each energy providing UE 115 in the group of energy providing UEs 115 may transmit respective energy transfer signals 215 at respective transmission power levels relative to the indicated transmission power level based on the pathloss. In some cases, a transmission power level (e.g., max transmit power, fixed or dynamic) associated with transmission of an energy transfer signal 215 to one energy harvesting UE 115 may be greater than a transmission power level associated with transmission of an energy transfer signal 215 to more than one energy harvesting UE 115.

In some cases, the energy transfer signal 215 may be associated with an energy per resource element (EPRE). In some examples, the EPRE associated with the energy transfer signal 215 may be based on (e.g., defined relative to) at least one of a control channel (e.g., physical downlink control channel (PDCCH) or physical sidelink control channel (PSCCH)) or data channel (e.g., physical downlink shared channel (PDSCH), physical sidelink shared channel (PSSCH), or physical uplink shared channel (PUSCH)) used by the UE 115-a to transmit the energy transfer signal 215.

Additionally, or alternatively, EPRE for demodulation reference signal (DMRS) associated with the energy transfer signal 215 may be based on (e.g., defined relative to) at least one of a control channel (e.g., PDCCH or PSCCH) or data channel (e.g., PDSCH, PSSCH, or PUSCH) used by the UE 115-a to transmit the energy transfer signal 215. That is, the UE 115-a may transmit the energy transfer signal 215 and a data message simultaneously, such that a UE 115 receiving the data message may cancel out (e.g., remove) the energy transfer signal 215 based on the EPRE for DMRS. In some cases, the EPRE for DMRS may be the same as an EPRE for sidelink-reference signals (SL-RSs), PSCCH DMRS, PDCCH DMRS, PSSCH DMRS, PDSCH DMRS, PUSCH DMRS, or any combination thereof.

While much of the present disclosure is described in the context of the energy providing UE 115-a and the energy harvesting UE 115-b, this is not to be regarded as a limitation of the present disclosure. Indeed, it is contemplated herein that the energy providing wireless device may be a UE 115 and the energy harvesting wireless device may be a UE 115. In this regard, the energy providing wireless device, the energy harvesting wireless device, or both, may be a network entity 105.

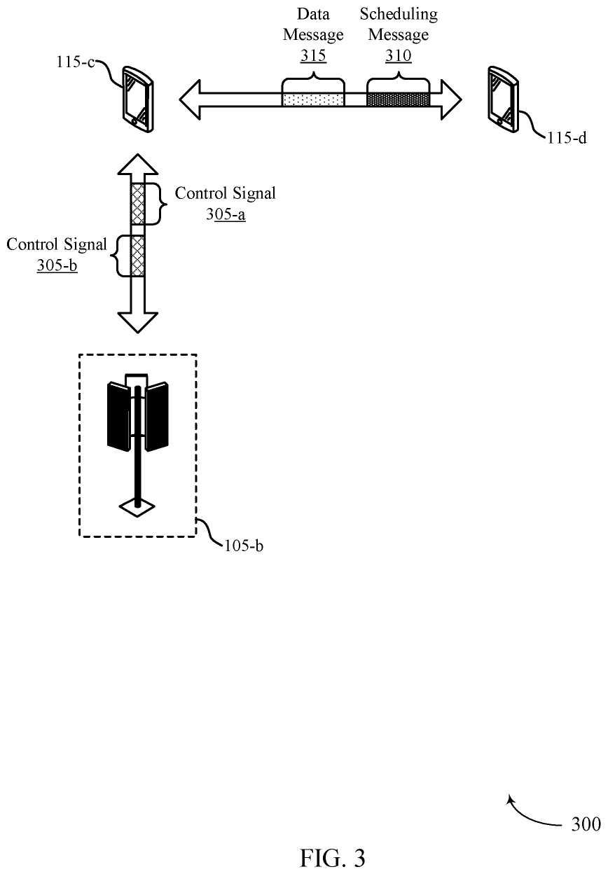

FIG. 3 illustrates an example of a wireless communications system 300 that supports power control for power providers and energy harvesting transmitters in accordance with one or more aspects of the present disclosure. In some examples, the wireless communications system 300 may implement or be implemented by aspects of the wireless communications system 100 and the wireless communications system 200. For example, the wireless communications system 300 may include one or more network entities 105 (e.g., a network entity 105-b) and one or more UEs 115 (e.g., a UE 115-c and a UE 115-d), which may be examples of the corresponding devices described with reference to FIG. 1. In the example of FIG. 3, the network entity 105-b may be examples of a CU 160, a DU 165, an RU 170, a base station 140, an IAB node 104, or one or more other network nodes as described with reference to FIG. 1. In some cases, a UE 115-b, which may be an energy harvesting UE 115-b, may receive a control message 305-b activating a first data transmission power control scheme of a set of data transmission power control schemes supported by the UE 115-c.

The wireless communications system 300 may support power control for transmission of one or more data messages by an energy harvesting wireless device, such as a UE 115-c, which may be an example of an energy harvesting UE 115-c. In some cases, the UE 115-c may receive, from a network entity 105-b, a control message 305-a indicating a set of data transmission power control schemes, where each data transmission power control scheme specifies how the UE 115-c is to determine a transmission power level (e.g., transmit power) for transmission of a data message 315. Additionally, the UE 115-c may receive a control message 305-b activating (e.g., or deactivating) a first data transmission power control scheme from the set of data transmission power control schemes. In some cases, activating the first data transmission power control scheme may be based on one or more carriers associated with the data message 315, a bandwidth part associated with the data message 315 (e.g., sidelink bandwidth part, uplink bandwidth part, downlink bandwidth part), a resource pool associated with the data message 315, a congestion level, a QoS, or any combination thereof. The UE 115-c may transmit, to a UE 115-d, a scheduling message 310 scheduling transmission of the data message 315. Further, the UE 115-c may transmit the data message 315 at a transmission power level in accordance with the first data transmission power control scheme.

In some cases, the first data transmission power control scheme may indicate that the UE 115-c is to transmit the data message 315 at a defined (e.g., constant) transmission power level based on an indication (e.g., layer 1, layer 2, or layer 3 indication or pre-configuration) transmitted to or received from an additional wireless device (e.g., a network entity 105, a CU 160, a UE 115, a PLC, an RF power emitting controller), such as the network entity 105-b (e.g., to avoid tracking pathloss or to avoid performing open-loop power control). For example, the UE 115-c may receive, from the network entity 105-b, control signaling (e.g., SCI, MAC-CE, RRC, DCI, or UCI) associated with the data message 315 (e.g., or received prior to the data message 315 transmission) indicating a first transmission power level. As such, the UE 115-c may transmit, to the UE 115-d, the data message 315 at the first transmission power level. In some cases, the UE 115-c may receive additional control signaling indicating a second (e.g., updated) transmission power level associated with the first data transmission power control scheme, such that the UE 115-c may transmit an additional data message 315 (e.g., scheduled via an additional scheduling message 310) at the second transmission power level (e.g., the transmission power level may be dynamically changed from time to time). In such cases, the transmission power level (e.g., constant power level) may be based on a power class or power type of the UE 115-c, a current charging rate at the UE 115-c (e.g., from RF or other technologies), a threshold (e.g., required by RF) charging rate of the UE 115-c, a QoS of charging at the UE 115-c, a capacity of an energy storage device at the UE 115-c, a discharge rate of the UE 115-c, a charging priority associated with the UE 115-c, a priority associated with the data message 315, a quality of service associated with data transmission by the UE 115-c, a data cast type, a packet delay budget, or any combination thereof. For example, a defined transmission power level associated with a high charging rate of the UE 115-c may be greater than a defined transmission power level associated with a low charging rate of the UE 115-c.

In some cases, the first data transmission power control scheme may indicate that the UE 115-c is to transmit the data message 315 at a transmission power level (e.g., at a full power level). In some examples, the UE 115-c may transmit at this power based on a power class of the UE 115-c. The power class of the UE 115-c may be associated with a charging rate of the UE 115-c, a power density (e.g., upon arrival of the data message 315) at the UE 115-c, a battery status (e.g., current battery status) of the UE 115-c, a QoS of charging at the UE 115-c, and one or more threshold (e.g., regulatory requirements) associated with the UE 115-c. For example, the UE 115-c may be associated with a high charging rate and may transmit the data message 315 at a higher transmission power level than a transmission power level associated with a low charging rate (e.g., due to power being available more quickly).

In some cases, the first data transmission power control scheme may indicate that the UE 115-c is to transmit the data message 315 at a transmission power level based on a pathloss (e.g., open-loop or closed-loop pathloss). For example, the UE 115-c may measure a pathloss (e.g., open-loop) associated with communications between the UE 115-c and one or more additional wireless devices. In some cases, the pathloss may be a downlink pathloss-based open-loop power control, an uplink pathloss-based open-loop power control, a sidelink pathloss-based open-loop power control, or any combination thereof. Additionally, or alternatively, the pathloss may be based on a frequency range associated with the communications, antennas at the UE 115-c used to transmit or receive the communications, or the like thereof.

In some cases, the first data transmission power control scheme may indicate that the UE 115-c is to transmit the data message 315 at a transmission power level based on a charging rate of the UE 115-c, a battery status (e.g., current battery status) of the UE 115-c, a QoS of charging at the UE 115-c, a discharge rate of the UE 115-c, a priority (e.g., level 1 and/or level 2 priority) associated with the data message 315 (e.g., that the UE 115-c is transmitting), a QoS associated with data transmission by the UE 115-c, a data cast type (e.g., unicast transmission to one UE 115, groupcast transmission to a group of UEs 115, multicast transmission to all UEs 115), a packet delay budget (e.g., remaining packet delay budget of data that the UE 115-c is transmitting), or any combination thereof (e.g., to perform closed-loop power control). In an example, the energy cast type (e.g., unicast, groupcast, broadcast) may be for a single or multiple energy harvesting UEs, and may be signaled to change a single parameter, multiple parameters, or all parameters, described herein, including, for example, a maximum transmission power level, a fixed transmission power level, a dynamically change a first transmission power level to a second transmission power level, or the like, to energy harvesting UEs communicating one or more data messages for a particular cast type. In an example, the UE 115-c may operate at a high discharge rate, such that the UE 115-c may transmit the data message 315 at a lower transmission power level (e.g., compared to a low discharge rate) to account for the high discharge rate.

In some cases, the first data transmission power control scheme may be associated with a lowest transmission power level from a set of transmission power levels associated with the set of data transmission power control schemes. That is, the first data transmission power control scheme may be associated with a lowest transmission power level of the aforementioned transmission power levels.

It is noted that the techniques discussed in FIGS. 2 and 3 may be used together, with an energy transfer power control scheme used to by an energy providing UE to charge an energy harvesting UE, and the energy harvesting UE using a data transmission power control scheme to determine and use a power control level for transmitting a data message.

While much of the present disclosure is described in the context of the energy harvesting UE 115-c, this is not to be regarded as a limitation of the present disclosure. Indeed, it is contemplated herein that the energy harvesting wireless device may be a UE 115. In this regard, the energy harvesting wireless device may be a network entity 105.

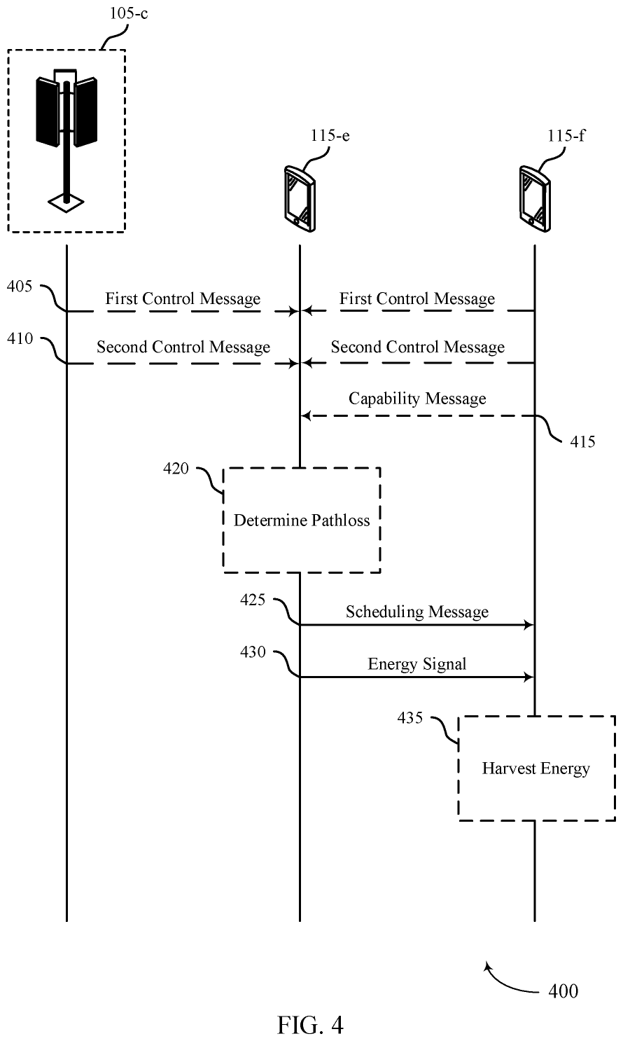

FIG. 4 illustrates an example of a process flow 400 that supports power control for power providers and energy harvesting transmitters in accordance with one or more aspects of the present disclosure. In some examples, the process flow 400 may implement or be implemented by aspects of the wireless communications system 100, the wireless communications system 200, and the wireless communications system 300. For example, the process flow 400 may include one or more network entities 105 (e.g., a network entity 105-c) and one or more UEs 115 (e.g., a UE 115-e and a UE 115-f), which may be examples of the corresponding devices described with reference to FIG. 1. In the example of FIG. 4, the network entity 105-c may be examples of a CU 160, a DU 165, an RU 170, a base station 140, an IAB node 104, or one or more other network nodes as described with reference to FIG. 1. In some cases, a UE 115-e, which may be an energy providing UE 115-e, may receive a second control message activating a first data transmission power control scheme of a set of data transmission power control schemes supported by the UE 115-e.

At 405, the UE 115-e may receive a first control message indicating a set of energy transfer power control schemes. In some cases, the UE 115-e may receive the first control message from the network entity 105-c. In some other cases, the UE 115-e may receive the first control message from the UE 115-f, which may be an energy harvesting UE 115-f.

At 410, the UE 115-e may receive a second control message indicating activation of a first energy transfer power control scheme of the set of energy transfer power control schemes. In some cases, the UE 115-e may receive the second control message from the network entity 105-c. In some other cases, the UE 115-e may receive the second control message from the UE 115-f. Additionally, activating the first energy transfer power control scheme may be based on one or more carriers associated with the energy transfer signal, a bandwidth part associated with the energy transfer signal (e.g., sidelink bandwidth part, uplink bandwidth part, downlink bandwidth part), a resource pool associated with the energy transfer signal, a congestion level, a quality of service, a priority level, or any combination thereof.

In some cases, the first energy transfer power control scheme may indicate that the UE 115-e is to transmit at a defined transmission power level in accordance with an indication received from a second wireless device, such as the network entity 105-c or the UE 115-f. For example, the UE 115-e may receive control signaling indicating a first defined transmission power level. Additionally, the UE 115-g may receive additional control signaling indicating a second (e.g., updated) defined transmission power level.

In some other cases, the first energy transfer power control scheme may indicate that the UE 115-e is to transmit the energy transfer signal at the transmission power level based at least in part on a power class. In some examples, the UE 115-e may receive, from the UE 115-f, an indication of the power class.

In some cases, the first energy transfer power control scheme may indicate that the UE 115-e is to transmit the energy transfer signal at the transmission power level based at least in part on a pathloss, where the pathloss is a downlink pathloss, a sidelink pathloss, or an uplink pathloss. In some cases, at 415, the UE 115-e may measure the pathloss associated with communications between the UE 115-e and the UE 115-f, where the UE 115-e initiated scheduling of the energy transfer signal, selected or requested energy transfer resources associated with the energy transfer signal, initiated transmission of the energy transfer signal, or is associated with an indication provided in the first control message. In some cases, the UE 115-e may receive an indication of the pathloss from a second wireless device.

In some cases, the first energy transfer power control scheme may be associated a lowest transmission power level of a set of transmissions power levels associated with the set of energy transfer power control schemes.

In some cases, at 420, the UE 115-e may receive, from the UE 115-f, a capability message indicating one or more parameters associated with the UE 115-f. For example, the UE 115-f may transmit, to the UE 115-e, an indication of a charging rate of the UE 115-e, a QoS of charging of the UE 115-e, a battery status of the UE 115-e, a discharge rate of the UE 115-e, a charging priority associated with the UE 115-e, an energy cast type, or any combination thereof. In some cases, the transmission power level may be based on the charging rate, the quality of service of charging, the battery status, the discharge rate, the charging priority, the energy cast type, or any combination thereof.

At 425, the UE 115-e may transmit, to the UE 115-f, a scheduling message to schedule transmission of an energy transfer signal. Alternatively (e.g., not depicted in FIG. 4), the UE 115-f may transmit a request to the UE 115-e, requesting transmission of the energy transfer signal.

At 430, the UE 115-e may transmit, to the UE 115-f, the energy transfer signal at a transmission power level in accordance with the first energy transfer power control scheme. In some cases, an EPRE associated with the energy transfer signal may be based on a control channel or a shared channel used to transmit the energy transfer signal. Additionally, the EPRE associated with the energy transfer signal may be further associated with a DMRS.

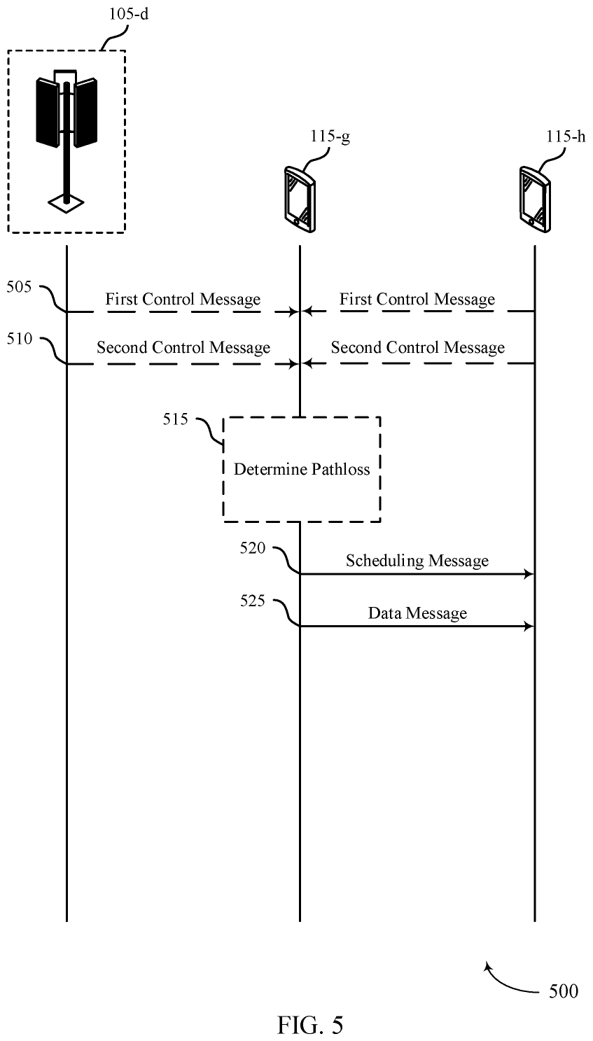

In some cases, at 435, the UE 115-f may perform an energy harvesting procedure to charge an energy storage device, such as a rechargeable battery, associated with the UE 115-f. In some cases, the UE 115-f may perform the energy harvesting procedure in accordance with an activated data transmission power control scheme, as described with reference to FIG. 5.

While much of the present disclosure is described in the context of the energy providing UE 115-e and the energy harvesting UE 115-f, this is not to be regarded as a limitation of the present disclosure. Indeed, it is contemplated herein that the energy providing wireless device may be a UE 115 and the energy harvesting wireless device may be a UE 115. In this regard, the energy providing wireless device, the energy harvesting wireless device, or both, may be a network entity 105.

FIG. 5 illustrates an example of a process flow 500 that supports power control for power providers and energy harvesting transmitters in accordance with one or more aspects of the present disclosure. In some examples, the process flow 400 may implement or be implemented by aspects of the wireless communications system 100, the wireless communications system 200, the wireless communications system 300, and the process flow 400. For example, the process flow 500 may include one or more network entities 105 (e.g., a network entity 105-d) and one or more UEs 115 (e.g., a UE 115-g and a UE 115-h), which may be examples of the corresponding devices described with reference to FIG. 1. In the example of FIG. 5, the network entity 105-d may be examples of a CU 160, a DU 165, an RU 170, a base station 140, an IAB node 104, or one or more other network nodes as described with reference to FIG. 1. In some cases, a UE 115-g, which may be an energy harvesting UE 115-g, may receive a second control message activating a first data transmission power control scheme of a set of data transmission power control schemes supported by the UE 115-g.

At 505, the UE 115-g may receive a first control message indicating a set of data transmission power control schemes. In some cases, the UE 115-g may receive the first control message from the network entity 105-d. In some other cases, the UE 115-g may receive the first control message from the UE 115-h.

At 510, the UE 115-g may receive a second control message indicating activation of a first data transmission power control scheme of the set of data transmission power control schemes. In some cases, the UE 115-g may receive the second control message from the network entity 105-d. In some other cases, the UE 115-g may receive the second control message from the UE 115-h. Additionally, activating the first data transmission power control scheme may be based on one or more carriers associated with the data message, a bandwidth part associated with the data message (e.g., sidelink bandwidth part, uplink bandwidth part, downlink bandwidth part), a resource pool associated with the data message, a congestion level, a quality of service, or any combination thereof.

In some cases, the first data transmission power control scheme may indicate that the UE 115-g is to transmit at a defined transmission power level in accordance with an indication received from a second wireless device, such as the network entity 105-d or the UE 115-h. For example, the UE 115-g may receive control signaling indicating a first defined transmission power level. Additionally, the UE 115-g may receive additional control signaling indicating a second (e.g., updated) defined transmission power level.

In some other cases, the first data transmission power control scheme may indicate that the UE 115-g is to transmit the data message at the transmission power level based at least in part on a power class (e.g., of the UE 115-g).

In some cases, the first data transmission power control scheme may indicate that the UE 115-g is to transmit the data message at the transmission power level based at least in part on a pathloss, where the pathloss is a downlink pathloss, a sidelink pathloss, or an uplink pathloss. In some cases, at 515, the UE 115-g may measure the pathloss associated with communications between the UE 115-g and the UE 115-h, where the UE 115-g initiated scheduling of the data message, selected or requested energy transfer resources associated with the data message, initiated transmission of the data message, or is associated with an indication provided in the first control message. In some cases, the UE 115-g may receive an indication of the pathloss from a second wireless device.

In some cases, the first data transmission power control scheme may be associated a lowest transmission power level of a set of transmissions power levels associated with the set of data transmission power control schemes.

At 520, the UE 115-g may transmit, to the UE 115-h, a scheduling message to schedule transmission of a data message. Alternatively (e.g., not depicted in FIG. 4), the UE 115-h may transmit a request to the UE 115-g, requesting transmission of the data message.

At 525, the UE 115-g may transmit, to the UE 115-h, the data message at a transmission power level in accordance with the first data transmission power control scheme.

While much of the present disclosure is described in the context of the energy providing UE 115-g and the energy harvesting UE 115-h, this is not to be regarded as a limitation of the present disclosure. Indeed, it is contemplated herein that the energy providing wireless device may be a UE 115 and the energy harvesting wireless device may be a UE 115. In this regard, the energy providing wireless device, the energy harvesting wireless device, or both, may be a network entity 105.

While much of the present disclosure is described in the context of the energy harvesting UE 115-g, this is not to be regarded as a limitation of the present disclosure. Indeed, it is contemplated herein that the energy harvesting wireless device may be a UE 115. In this regard, the energy harvesting wireless device may be a network entity 105.

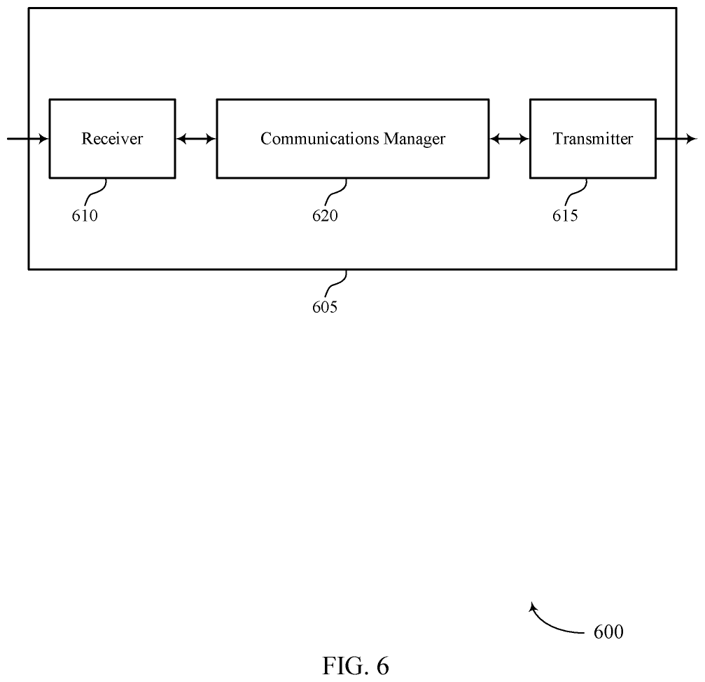

FIG. 6 shows a block diagram 600 of a device 605 that supports power control for power providers and energy harvesting transmitters in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power control for power providers and energy harvesting transmitters). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power control for power providers and energy harvesting transmitters). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of power control for power providers and energy harvesting transmitters as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at an energy providing wireless device in accordance with examples as disclosed herein. For example, the communications manager 620 may be configured as or otherwise support a means for communicating control signaling indicating a set of multiple energy transfer power control schemes. The communications manager 620 may be configured as or otherwise support a means for communicating a control message indicating activation of a first energy transfer power control scheme of the set of multiple energy transfer power control schemes. The communications manager 620 may be configured as or otherwise support a means for communicating, to one or more energy harvesting wireless devices, a scheduling message to schedule transmission of an energy transfer signal. The communications manager 620 may be configured as or otherwise support a means for transmitting the energy transfer signal at a transmission power level determined in accordance with the first energy transfer power control scheme.

Additionally, or alternatively, the communications manager 620 may support wireless communications at an energy harvesting wireless device in accordance with examples as disclosed herein. For example, the communications manager 620 may be configured as or otherwise support a means for communicating control signaling indicating a set of multiple data transmission power control schemes. The communications manager 620 may be configured as or otherwise support a means for communicating a control message indicating activation of a first data transmission power control scheme of the set of multiple data transmission power control schemes. The communications manager 620 may be configured as or otherwise support a means for communicating a scheduling message to schedule transmission of a data message. The communications manager 620 may be configured as or otherwise support a means for transmitting the data message at a transmission power level determined in accordance with the first data transmission power control scheme.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for power control for power providers and energy harvesting transmitters which may result in reduced processing, reduced power consumption, and more efficient utilization of communication resources, among other advantages.

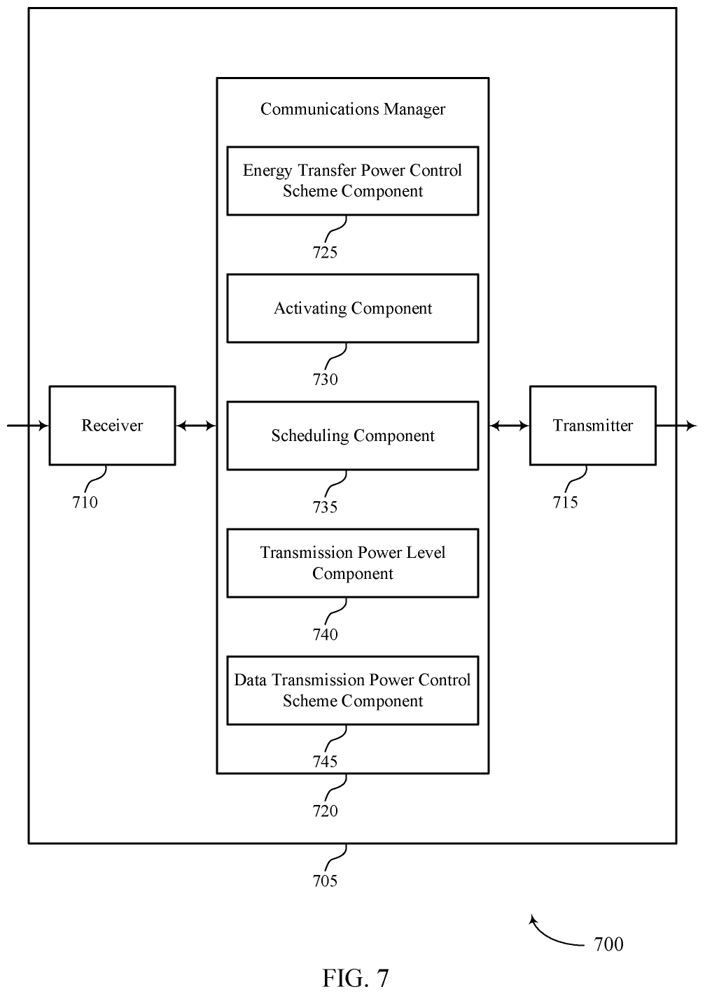

FIG. 7 shows a block diagram 700 of a device 705 that supports power control for power providers and energy harvesting transmitters in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to power control for power providers and energy harvesting transmitters). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to power control for power providers and energy harvesting transmitters). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of power control for power providers and energy harvesting transmitters as described herein. For example, the communications manager 720 may include an energy transfer power control scheme component 725, an activating component 730, a scheduling component 735, a transmission power level component 740, a data transmission power control scheme component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at an energy providing wireless device in accordance with examples as disclosed herein. The energy transfer power control scheme component 725 may be configured as or otherwise support a means for communicating control signaling indicating a set of multiple energy transfer power control schemes. The activating component 730 may be configured as or otherwise support a means for communicating a control message indicating activation of a first energy transfer power control scheme of the set of multiple energy transfer power control schemes. The scheduling component 735 may be configured as or otherwise support a means for communicating, to one or more energy harvesting wireless devices, a scheduling message to schedule transmission of an energy transfer signal. The transmission power level component 740 may be configured as or otherwise support a means for transmitting the energy transfer signal at a transmission power level determined in accordance with the first energy transfer power control scheme.

Additionally, or alternatively, the communications manager 720 may support wireless communications at an energy harvesting wireless device in accordance with examples as disclosed herein. The data transmission power control scheme component 745 may be configured as or otherwise support a means for communicating control signaling indicating a set of multiple data transmission power control schemes. The activating component 730 may be configured as or otherwise support a means for communicating a control message indicating activation of a first data transmission power control scheme of the set of multiple data transmission power control schemes. The scheduling component 735 may be configured as or otherwise support a means for communicating a scheduling message to schedule transmission of a data message. The transmission power level component 740 may be configured as or otherwise support a means for transmitting the data message at a transmission power level determined in accordance with the first data transmission power control scheme.

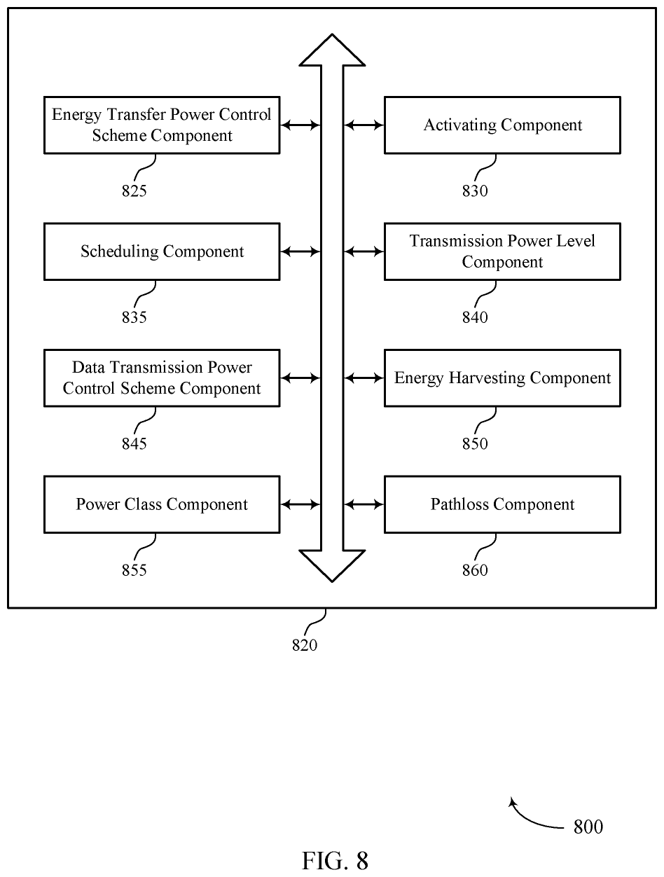

FIG. 8 shows a block diagram 800 of a communications manager 820 that supports power control for power providers and energy harvesting transmitters in accordance with one or more aspects of the present disclosure. The communications manager 820 may be an example of aspects of a communications manager 620, a communications manager 720, or both, as described herein. The communications manager 820, or various components thereof, may be an example of means for performing various aspects of power control for power providers and energy harvesting transmitters as described herein. For example, the communications manager 820 may include an energy transfer power control scheme component 825, an activating component 830, a scheduling component 835, a transmission power level component 840, a data transmission power control scheme component 845, an energy harvesting component 850, a power class component 855, a pathloss component 860, or any combination thereof. Each of these components may communicate, directly or indirectly, with one another (e.g., via one or more buses).

The communications manager 820 may support wireless communications at an energy providing wireless device in accordance with examples as disclosed herein. The energy transfer power control scheme component 825 may be configured as or otherwise support a means for communicating control signaling indicating a set of multiple energy transfer power control schemes. The activating component 830 may be configured as or otherwise support a means for communicating a control message indicating activation of a first energy transfer power control scheme of the set of multiple energy transfer power control schemes. The scheduling component 835 may be configured as or otherwise support a means for communicating, to one or more energy harvesting wireless devices, a scheduling message to schedule transmission of an energy transfer signal. The transmission power level component 840 may be configured as or otherwise support a means for transmitting the energy transfer signal at a transmission power level determined in accordance with the first energy transfer power control scheme.

In some examples, the first energy transfer power control scheme indicates that the energy providing wireless device is to transmit at a defined transmission power level in accordance with an indication received from a second wireless device, and the transmission power level component 840 may be configured as or otherwise support a means for receiving a second control message indicating an updated defined transmission power level for the first energy transfer power control scheme. In some examples, the first energy transfer power control scheme indicates that the energy providing wireless device is to transmit at a defined transmission power level in accordance with an indication received from a second wireless device, and the transmission power level component 840 may be configured as or otherwise support a means for transmitting a second energy transfer signal at the updated defined transmission power level determined in accordance with the first energy transfer power control scheme.

In some examples, the first energy transfer power control scheme indicates that the energy providing wireless device is to transmit the energy transfer signal at the transmission power level based on a power class.

In some examples, the power class component 855 may be configured as or otherwise support a means for receiving, from an energy harvesting wireless device of the one or more energy harvesting wireless devices, an indication of the power class.

In some examples, the first energy transfer power control scheme indicates that the energy providing wireless device is to transmit the energy transfer signal at the transmission power level based on a pathloss.

In some examples, the pathloss is a downlink pathloss, a sidelink pathloss, or an uplink pathloss.

In some examples, the pathloss component 860 may be configured as or otherwise support a means for measuring the pathloss associated with communications between the energy providing wireless device and one or more wireless devices.

In some examples, the energy providing wireless device initiated scheduling of the energy transfer signal, selected or requested energy transfer resources associated with the energy transfer signal, initiated transmission of the energy transfer signal, or is associated with an indication provided in the control message.

In some examples, the pathloss component 860 may be configured as or otherwise support a means for receiving, from a second wireless device, an indication of the pathloss.

In some examples, the energy transfer power control scheme component 825 may be configured as or otherwise support a means for receiving, from an energy harvesting wireless device of the one or more energy harvesting wireless devices, an indication of a charging rate of the energy harvesting wireless device, a quality of service of charging of the energy harvesting wireless device, a battery status of the energy harvesting wireless device, a discharge rate of the energy harvesting wireless device, a charging priority associated with the energy harvesting wireless device, an energy cast type, or any combination thereof, wherein the transmission power level is based at least in part on the charging rate, the quality of service of charging, the battery status, the discharge rate, the charging priority, the energy cast type, or any combination thereof.

In some examples, the first energy transfer power control scheme is associated a lowest transmission power level of a set of multiple transmissions power levels associated with the set of multiple energy transfer power control schemes.

In some examples, activating the first energy transfer power control scheme is based on one or more carriers associated with the energy transfer signal, a bandwidth part associated with the energy transfer signal, a resource pool associated with the energy transfer signal, a congestion level, a quality of service, or any combination thereof.

In some examples, an energy per resource element associated with the energy transfer signal is based on a control channel or a shared channel used to transmit the energy transfer signal.

In some examples, the energy per resource element associated with the energy transfer signal is further associated with a demodulation reference signal.

In some examples, the energy providing wireless device is a network entity or a UE.

Additionally, or alternatively, the communications manager 820 may support wireless communications at an energy harvesting wireless device in accordance with examples as disclosed herein. The data transmission power control scheme component 845 may be configured as or otherwise support a means for communicating control signaling indicating a set of multiple data transmission power control schemes. In some examples, the activating component 830 may be configured as or otherwise support a means for communicating a control message indicating activation of a first data transmission power control scheme of the set of multiple data transmission power control schemes. In some examples, the scheduling component 835 may be configured as or otherwise support a means for communicating a scheduling message to schedule transmission of a data message. In some examples, the transmission power level component 840 may be configured as or otherwise support a means for transmitting the data message at a transmission power level determined in accordance with the first data transmission power control scheme.

In some examples, the first data transmission power control scheme indicates that the energy harvesting wireless device is to transmit at a defined transmission power level in accordance with an indication received from a second wireless device, and the transmission power level component 840 may be configured as or otherwise support a means for receiving a second control message indicating an updated defined transmission power level for the first data transmission power control scheme. In some examples, the first data transmission power control scheme indicates that the energy harvesting wireless device is to transmit at a defined transmission power level in accordance with an indication received from a second wireless device, and the transmission power level component 840 may be configured as or otherwise support a means for transmitting a second data message at the updated defined transmission power level determined in accordance with the first data transmission power control scheme.

In some examples, the first data transmission power control scheme indicates that the energy harvesting wireless device is to transmit the data message at the transmission power level based on a power class.

In some examples, the power class component 855 may be configured as or otherwise support a means for transmitting, to an energy providing wireless device, an indication of the power class.

In some examples, the first data transmission power control scheme indicates that the energy harvesting wireless device is to transmit the data message at the transmission power level based on a pathloss.

In some examples, the pathloss is a downlink pathloss, a sidelink pathloss, or an uplink pathloss.

In some examples, the pathloss component 860 may be configured as or otherwise support a means for measuring the pathloss associated with communications between the energy harvesting wireless device and one or more wireless devices.

In some examples, the energy harvesting wireless device initiated scheduling of an energy transfer signal, selected or requested energy transfer resources associated with the energy transfer signal, initiated transmission of the energy transfer signal, or is associated with an indication provided in the control message.

In some examples, the pathloss component 860 may be configured as or otherwise support a means for receiving, from a second wireless device, an indication of the pathloss.

In some examples, the transmission power level is based on a charging rate of the energy harvesting wireless device, a quality of service of charging of the energy harvesting wireless device, a battery status of the energy harvesting wireless device, a discharge rate of the energy harvesting wireless device, a charging priority associated with the energy harvesting wireless device, a priority associated with the data message, a quality of service associated with data transmission by the energy harvesting wireless device, a data cast type, a packet delay budget, or any combination thereof.

In some examples, the first data transmission power control scheme is associated a lowest transmission power level of a set of multiple transmissions power levels associated with the set of multiple data transmission power control schemes.

In some examples, activating the first data transmission power control scheme is based on one or more carriers associated with an data message, a bandwidth part associated with the data message, a resource pool associated with the data message, a congestion level, a quality of service, or any combination thereof.

In some examples, the energy harvesting component 850 may be configured as or otherwise support a means for performing an energy harvesting procedure to charge an energy storage device associated with the energy harvesting wireless device in accordance with the first data transmission power control scheme.

In some examples, the energy harvesting wireless device is a network entity or a UE.

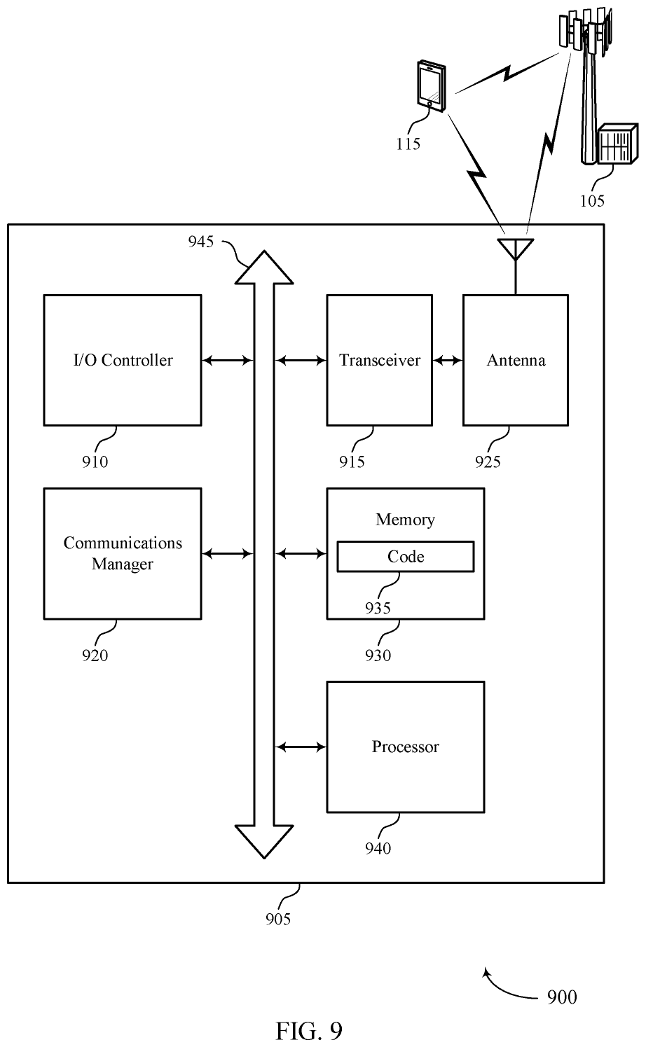

FIG. 9 shows a diagram of a system 900 including a device 905 that supports power control for power providers and energy harvesting transmitters in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting power control for power providers and energy harvesting transmitters). For example, the device 905 or a component of the device 905 may include a processor 940 and memory 930 coupled with or to the processor 940, the processor 940 and memory 930 configured to perform various functions described herein.

The communications manager 920 may support wireless communications at an energy providing wireless device in accordance with examples as disclosed herein. For example, the communications manager 920 may be configured as or otherwise support a means for communicating control signaling indicating a set of multiple energy transfer power control schemes. The communications manager 920 may be configured as or otherwise support a means for communicating a control message indicating activation of a first energy transfer power control scheme of the set of multiple energy transfer power control schemes. The communications manager 920 may be configured as or otherwise support a means for communicating, to one or more energy harvesting wireless devices, a scheduling message to schedule transmission of an energy transfer signal. The communications manager 920 may be configured as or otherwise support a means for transmitting the energy transfer signal at a transmission power level determined in accordance with the first energy transfer power control scheme.

Additionally, or alternatively, the communications manager 920 may support wireless communications at an energy harvesting wireless device in accordance with examples as disclosed herein. For example, the communications manager 920 may be configured as or otherwise support a means for communicating control signaling indicating a set of multiple data transmission power control schemes. The communications manager 920 may be configured as or otherwise support a means for communicating a control message indicating activation of a first data transmission power control scheme of the set of multiple data transmission power control schemes. The communications manager 920 may be configured as or otherwise support a means for communicating a scheduling message to schedule transmission of a data message. The communications manager 920 may be configured as or otherwise support a means for transmitting the data message at a transmission power level determined in accordance with the first data transmission power control scheme.

By including or configuring the communications manager 920 in accordance with examples as described herein, the device 905 may support techniques for power control for power providers and energy harvesting transmitters which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of power control for power providers and energy harvesting transmitters as described herein, or the processor 940 and the memory 930 may be otherwise configured to perform or support such operations.

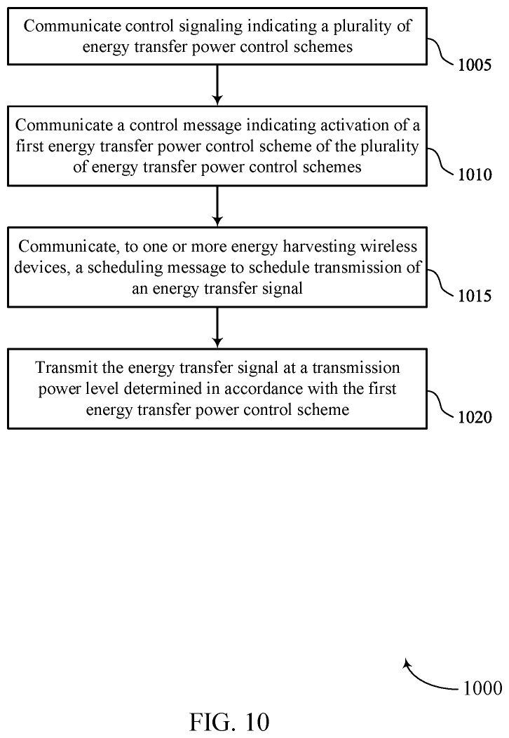

FIG. 10 shows a flowchart illustrating a method 1000 that supports power control for power providers and energy harvesting transmitters in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include communicating control signaling indicating a set of multiple energy transfer power control schemes. The operations of 1005 may be performed in accordance with examples as disclosed herein. In some examples, aspects of the operations of 1005 may be performed by an energy transfer power control scheme component 825 as described with reference to FIG. 8.

At 1010, the method may include communicating a control message indicating activation of a first energy transfer power control scheme of the set of multiple energy transfer power control schemes. The operations of 1010 may be performed in accordance with examples as disclosed herein. In some examples, aspects of the operations of 1010 may be performed by an activating component 830 as described with reference to FIG. 8.

At 1015, the method may include communicating, to one or more energy harvesting wireless devices, a scheduling message to schedule transmission of an energy transfer signal. The operations of 1015 may be performed in accordance with examples as disclosed herein. In some examples, aspects of the operations of 1015 may be performed by a scheduling component 835 as described with reference to FIG. 8.

At 1020, the method may include transmitting the energy transfer signal at a transmission power level determined in accordance with the first energy transfer power control scheme. The operations of 1020 may be performed in accordance with examples as disclosed herein. In some examples, aspects of the operations of 1020 may be performed by a transmission power level component 840 as described with reference to FIG. 8.

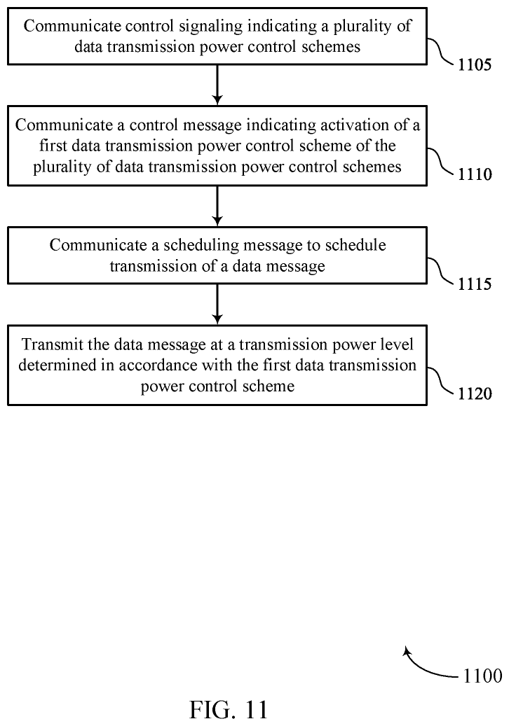

FIG. 11 shows a flowchart illustrating a method 1100 that supports power control for power providers and energy harvesting transmitters in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include communicating control signaling indicating a set of multiple data transmission power control schemes. The operations of 1105 may be performed in accordance with examples as disclosed herein. In some examples, aspects of the operations of 1105 may be performed by a data transmission power control scheme component 845 as described with reference to FIG. 8.

At 1110, the method may include communicating a control message indicating activation of a first data transmission power control scheme of the set of multiple data transmission power control schemes. The operations of 1110 may be performed in accordance with examples as disclosed herein. In some examples, aspects of the operations of 1110 may be performed by an activating component 830 as described with reference to FIG. 8.

At 1115, the method may include communicating a scheduling message to schedule transmission of a data message. The operations of 1115 may be performed in accordance with examples as disclosed herein. In some examples, aspects of the operations of 1115 may be performed by a scheduling component 835 as described with reference to FIG. 8.

At 1120, the method may include transmitting the data message at a transmission power level determined in accordance with the first data transmission power control scheme. The operations of 1120 may be performed in accordance with examples as disclosed herein. In some examples, aspects of the operations of 1120 may be performed by a transmission power level component 840 as described with reference to FIG. 8.

The following provides an overview of aspects of the present disclosure:

Aspect 1: A method for wireless communications at an energy providing wireless device, comprising: communicating control signaling indicating a plurality of energy transfer power control schemes; communicating a control message indicating activation of a first energy transfer power control scheme of the plurality of energy transfer power control schemes; communicating, to one or more energy harvesting wireless devices, a scheduling message to schedule transmission of an energy transfer signal; and transmitting the energy transfer signal at a transmission power level determined in accordance with the first energy transfer power control scheme.

Aspect 2: The method of aspect 1, wherein the first energy transfer power control scheme indicates that the energy providing wireless device is to transmit at a defined transmission power level in accordance with an indication received from a second wireless device, the method further comprising: receiving a second control message indicating an updated defined transmission power level for the first energy transfer power control scheme; and transmitting a second energy transfer signal at the updated defined transmission power level determined in accordance with the first energy transfer power control scheme.

Aspect 3: The method of aspect 1, wherein the first energy transfer power control scheme indicates that the energy providing wireless device is to transmit the energy transfer signal at the transmission power level based at least in part on a power class.

Aspect 4: The method of aspect 3, further comprising: receiving, from an energy harvesting wireless device of the one or more energy harvesting wireless devices, an indication of the power class.

Aspect 5: The method of aspect 1, wherein the first energy transfer power control scheme indicates that the energy providing wireless device is to transmit the energy transfer signal at the transmission power level based at least in part on a pathloss.

Aspect 6: The method of aspect 5, wherein the pathloss is a downlink pathloss, a sidelink pathloss, or an uplink pathloss.

Aspect 7: The method of any of aspects 5 through 6, further comprising: measuring the pathloss associated with communications between the energy providing wireless device and one or more wireless devices.

Aspect 8: The method of aspect 7, wherein the energy providing wireless device initiated scheduling of the energy transfer signal, selected or requested energy transfer resources associated with the energy transfer signal, initiated transmission of the energy transfer signal, or is associated with an indication provided in the control message.

Aspect 9: The method of any of aspects 5 through 6, further comprising: receiving, from a second wireless device, an indication of the pathloss.

Aspect 10: The method of aspect 1, further comprising: receiving, from an energy harvesting wireless device of the one or more energy harvesting wireless devices, an indication of a charging rate of the energy harvesting wireless device, a QoS of charging of the energy harvesting wireless device, a battery status of the energy harvesting wireless device, a discharge rate of the energy harvesting wireless device, a charging priority associated with the energy harvesting wireless device, an energy cast type, or any combination thereof, wherein the transmission power level is based at least in part on the charging rate, the QoS of charging, the battery status, the discharge rate, the charging priority, the energy cast type, or any combination thereof.

Aspect 11: The method of aspect 1, wherein the first energy transfer power control scheme is associated a lowest transmission power level of a plurality of transmissions power levels associated with the plurality of energy transfer power control schemes.

Aspect 12: The method of any of aspects 1 through 11, wherein activating the first energy transfer power control scheme is based at least in part on one or more carriers associated with the energy transfer signal, a BWP associated with the energy transfer signal, a resource pool associated with the energy transfer signal, a congestion level, a QoS, or any combination thereof.

Aspect 13: The method of any of aspects 1 through 12, wherein an energy per resource element associated with the energy transfer signal is based at least in part on a control channel or a shared channel used to transmit the energy transfer signal.

Aspect 14: The method of aspect 13, wherein the energy per resource element associated with the energy transfer signal is further associated with a demodulation reference signal.

Aspect 15: The method of any of aspects 1 through 14, wherein the energy providing wireless device is a network entity or a UE.

Aspect 16: A method for wireless communications at an energy harvesting wireless device, comprising: communicating control signaling indicating a plurality of data transmission power control schemes; communicating a control message indicating activation of a first data transmission power control scheme of the plurality of data transmission power control schemes; communicating a scheduling message to schedule transmission of a data message; and transmitting the data message at a transmission power level determined in accordance with the first data transmission power control scheme.

Aspect 17: The method of aspect 16, wherein the first data transmission power control scheme indicates that the energy harvesting wireless device is to transmit at a defined transmission power level in accordance with an indication received from a second wireless device, the method further comprising: receiving a second control message indicating an updated defined transmission power level for the first data transmission power control scheme; and transmitting a second data message at the updated defined transmission power level determined in accordance with the first data transmission power control scheme.

Aspect 18: The method of aspect 16, wherein the first data transmission power control scheme indicates that the energy harvesting wireless device is to transmit the data message at the transmission power level based at least in part on a power class.

Aspect 19: The method of aspect 18, further comprising: transmitting, to an energy providing wireless device, an indication of the power class.

Aspect 20: The method of aspect 16, wherein the first data transmission power control scheme indicates that the energy harvesting wireless device is to transmit the data message at the transmission power level based at least in part on a pathloss.

Aspect 21: The method of aspect 20, wherein the pathloss is a downlink pathloss, a sidelink pathloss, or an uplink pathloss.

Aspect 22: The method of any of aspects 20 through 21, further comprising: measuring the pathloss associated with communications between the energy harvesting wireless device and one or more wireless devices.

Aspect 23: The method of aspect 22, wherein the energy harvesting wireless device initiated scheduling of an energy transfer signal, selected or requested energy transfer resources associated with the energy transfer signal, initiated transmission of the energy transfer signal, or is associated with an indication provided in the control message.

Aspect 24: The method of any of aspects 20 through 21, further comprising: receiving, from a second wireless device, an indication of the pathloss.

Aspect 25: The method of aspect 16, wherein the transmission power level is based at least in part on a charging rate of the energy harvesting wireless device, a QoS of charging of the energy harvesting wireless device, a battery status of the energy harvesting wireless device, a discharge rate of the energy harvesting wireless device, a charging priority associated with the energy harvesting wireless device, a priority associated with the data message, a QoS associated with data transmission by the energy harvesting wireless device, a data cast type, a packet delay budget, or any combination thereof.

Aspect 26: The method of aspect 16, wherein the first data transmission power control scheme is associated a lowest transmission power level of a plurality of transmissions power levels associated with the plurality of data transmission power control schemes.

Aspect 27: The method of any of aspects 16 through 26, wherein activating the first data transmission power control scheme is based at least in part on one or more carriers associated with an data message, a BWP associated with the data message, a resource pool associated with the data message, a congestion level, a QoS, or any combination thereof.

Aspect 28: The method of any of aspects 16 through 27, further comprising: performing an energy harvesting procedure to charge an energy storage device associated with the energy harvesting wireless device in accordance with the first data transmission power control scheme.

Aspect 29: The method of any of aspects 16 through 28, wherein the energy harvesting wireless device is a network entity or a UE.

Aspect 30: An apparatus for wireless communications at an energy providing wireless device, comprising a processor; memory coupled with the processor; and instructions stored in the memory and executable by the processor to cause the apparatus to perform a method of any of aspects 1 through 15.

Aspect 31: An apparatus for wireless communications at an energy providing wireless device, comprising at least one means for performing a method of any of aspects 1 through 15.

Aspect 32: A non-transitory computer-readable medium storing code for wireless communications at an energy providing wireless device, the code comprising instructions executable by a processor to perform a method of any of aspects 1 through 15.

Aspect 33: An apparatus for wireless communications at an energy harvesting wireless device, comprising a processor; memory coupled with the processor; and instructions stored in the memory and executable by the processor to cause the apparatus to perform a method of any of aspects 16 through 29.

Aspect 34: An apparatus for wireless communications at an energy harvesting wireless device, comprising at least one means for performing a method of any of aspects 16 through 29.

Aspect 35: A non-transitory computer-readable medium storing code for wireless communications at an energy harvesting wireless device, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at an energy providing wireless device, comprising:
communicating control signaling indicating a plurality of energy transfer power control schemes;
communicating a control message indicating activation of a first energy transfer power control scheme of the plurality of energy transfer power control schemes;
communicating, to one or more energy harvesting wireless devices, a scheduling message to schedule transmission of an energy transfer signal; and
transmitting the energy transfer signal at a transmission power level determined in accordance with the first energy transfer power control scheme.

2. The method of claim 1, wherein the first energy transfer power control scheme indicates that the energy providing wireless device is to transmit at a defined transmission power level in accordance with an indication received from a second wireless device, the method further comprising:
receiving a second control message indicating an updated defined transmission power level for the first energy transfer power control scheme; and
transmitting a second energy transfer signal at the updated defined transmission power level determined in accordance with the first energy transfer power control scheme.

3. The method of claim 1, wherein the first energy transfer power control scheme indicates that the energy providing wireless device is to transmit the energy transfer signal at the transmission power level based at least in part on a power class.

4. The method of claim 3, further comprising:
receiving, from an energy harvesting wireless device of the one or more energy harvesting wireless devices, an indication of the power class.

5. The method of claim 1, wherein the first energy transfer power control scheme indicates that the energy providing wireless device is to transmit the energy transfer signal at the transmission power level based at least in part on a pathloss.

6. The method of claim 5, wherein the pathloss is a downlink pathloss, a sidelink pathloss, or an uplink pathloss.

7. The method of claim 5, further comprising:
measuring the pathloss associated with communications between the energy providing wireless device and one or more wireless devices.

8. The method of claim 7, wherein the energy providing wireless device initiated scheduling of the energy transfer signal, selected or requested energy transfer resources associated with the energy transfer signal, initiated transmission of the energy transfer signal, or is associated with an indication provided in the control message.

9. The method of claim 5, further comprising:
receiving, from a second wireless device, an indication of the pathloss.

10. The method of claim 1, further comprising:
receiving, from an energy harvesting wireless device of the one or more energy harvesting wireless devices, an indication of a charging rate of the energy harvesting wireless device, a quality of service of charging of the energy harvesting wireless device, a battery status of the energy harvesting wireless device, a discharge rate of the energy harvesting wireless device, a charging priority associated with the energy harvesting wireless device, an energy cast type, or any combination thereof, wherein the transmission power level is based at least in part on the charging rate, the quality of service of charging, the battery status, the discharge rate, the charging priority, the energy cast type, or any combination thereof.

11. The method of claim 1, wherein the first energy transfer power control scheme is associated a lowest transmission power level of a plurality of transmissions power levels associated with the plurality of energy transfer power control schemes.

12. The method of claim 1, wherein activating the first energy transfer power control scheme is based at least in part on one or more carriers associated with the energy transfer signal, a bandwidth part associated with the energy transfer signal, a resource pool associated with the energy transfer signal, a congestion level, a quality of service, or any combination thereof.

13. The method of claim 1, wherein an energy per resource element associated with the energy transfer signal is based at least in part on a control channel or a shared channel used to transmit the energy transfer signal.

14. The method of claim 13, wherein the energy per resource element associated with the energy transfer signal is further associated with a demodulation reference signal.

15. The method of claim 1, wherein the energy providing wireless device is a network entity or a user equipment (UE).

16. A method for wireless communications at an energy harvesting wireless device, comprising:
communicating control signaling indicating a plurality of data transmission power control schemes;
communicating a control message indicating activation of a first data transmission power control scheme of the plurality of data transmission power control schemes;
communicating a scheduling message to schedule transmission of a data message; and
transmitting the data message at a transmission power level determined in accordance with the first data transmission power control scheme.

17. The method of claim 16, wherein the first data transmission power control scheme indicates that the energy harvesting wireless device is to transmit at a defined transmission power level in accordance with an indication received from a second wireless device, the method further comprising:
receiving a second control message indicating an updated defined transmission power level for the first data transmission power control scheme; and
transmitting a second data message at the updated defined transmission power level determined in accordance with the first data transmission power control scheme.

18. The method of claim 16, wherein the first data transmission power control scheme indicates that the energy harvesting wireless device is to transmit the data message at the transmission power level based at least in part on a power class.

19. The method of claim 18, further comprising:
transmitting, to an energy providing wireless device, an indication of the power class.

20. The method of claim 16, wherein the first data transmission power control scheme indicates that the energy harvesting wireless device is to transmit the data message at the transmission power level based at least in part on a pathloss.

21. The method of claim 20, wherein the pathloss is a downlink pathloss, a sidelink pathloss, or an uplink pathloss.

22. The method of claim 20, further comprising:
measuring the pathloss associated with communications between the energy harvesting wireless device and one or more wireless devices.

23. The method of claim 22, wherein the energy harvesting wireless device initiated scheduling of an energy transfer signal, selected or requested energy transfer resources associated with the energy transfer signal, initiated transmission of the energy transfer signal, or is associated with an indication provided in the control message.

24. The method of claim 20, further comprising:
receiving, from a second wireless device, an indication of the pathloss.

25. The method of claim 16, wherein the transmission power level is based at least in part on a charging rate of the energy harvesting wireless device, a quality of service of charging of the energy harvesting wireless device, a battery status of the energy harvesting wireless device, a discharge rate of the energy harvesting wireless device, a charging priority associated with the energy harvesting wireless device, a priority associated with the data message, a quality of service associated with data transmission by the energy harvesting wireless device, a data cast type, a packet delay budget, or any combination thereof.

26. The method of claim 16, wherein the first data transmission power control scheme is associated a lowest transmission power level of a plurality of transmissions power levels associated with the plurality of data transmission power control schemes.

27. The method of claim 16, wherein activating the first data transmission power control scheme is based at least in part on one or more carriers associated with an data message, a bandwidth part associated with the data message, a resource pool associated with the data message, a congestion level, a quality of service, or any combination thereof.

28. The method of claim 16, further comprising:
performing an energy harvesting procedure to charge an energy storage device associated with the energy harvesting wireless device in accordance with the first data transmission power control scheme.

29. An apparatus for wireless communications at an energy providing wireless device, comprising:
a processor;
memory coupled with the processor; and
instructions stored in the memory and executable by the processor to cause the apparatus to:
communicate control signaling indicating a plurality of energy transfer power control schemes;
communicate a control message indicating activation of a first energy transfer power control scheme of the plurality of energy transfer power control schemes;
communicate, to one or more energy harvesting wireless devices, a scheduling message to schedule transmission of an energy transfer signal; and
transmit the energy transfer signal at a transmission power level determined in accordance with the first energy transfer power control scheme.

30. An apparatus for wireless communications at an energy harvesting wireless device, comprising:
a processor;
memory coupled with the processor; and
instructions stored in the memory and executable by the processor to cause the apparatus to:
communicate control signaling indicating a plurality of data transmission power control schemes;
communicate a control message indicating activation of a first data transmission power control scheme of the plurality of data transmission power control schemes;
communicate a scheduling message to schedule transmission of a data message; and
transmit the data message at a transmission power level determined in accordance with the first data transmission power control scheme.
